(19) United States
(12) Patent Application Publication
(10) Pub. No.: US 2014/0281630 A1
(43) Pub. Date: Sep. 18, 2014

(54) ELECTRONIC DEVICE WITH TWO DRIVING STRUCTURES

(71) Applicant: HON HAI PRECISION INDUSTRY CO., LTD., New Taipei (TW)

(72) Inventors: WEI-CHING CHIEN, New Taipei (TW); MENG-FENG KUO, New Taipei (TW); CHU-LIAO WANG, New Taipei (TW)

(73) Assignee: HON HAI PRECISION INDUSTRY CO., LTD., New Taipei (TW)

(21) Appl. No.: 14/060,769

(22) Filed: Oct. 23, 2013

(30) Foreign Application Priority Data
Mar. 12, 2013 (TW) 102108577

(51) Int. Cl. G06F 1/32

(52) U.S. Cl. CPC G06F 1/3234; G06F 1/3287
USPC 713/323

(57) ABSTRACT

An electronic device with two driving structures is capable of switching between a standby state and a working state. The electronic device includes a power supply, a processor and a driving circuit. The power supply is capable of outputting a first driving voltage or a second driving voltage. The processor detects whether the power supply outputs a first driving voltage and whether the electronic device receives a power-on instruction for powering on the electronic device. The processor outputs different controlling signals to control the driving circuit to output different voltages. The processor works in different states of different driving structures based on the received voltage outputted by the driving circuit.

### BACKGROUND

1. Technical Field

The present disclosure relates to an electronic device with two driving structures.

2. Description of Related Art

An electronic device, such as a TV set, is capable of being in a standby state. The electronic device includes a power supply, a driving circuit, and a processor. The driving circuit can be designed in a first or a second structure for providing different standby voltages to drive the processor when the electronic device is in the standby state. In the first structure of the driving circuit, the standby voltage is 5V, and in the second structure of the driving circuit, the standby voltage is 3.3V. However, when the driving circuit in the first structure connects to the processor driven by the driving circuit in the second structure, the processor may be damaged.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the electronic device and energy efficiency indicating method thereof. Moreover, in the drawings, like reference numerals designate corresponding parts throughout the several views.

FIG. 1 is a block diagram of an electronic device in accordance with an embodiment.

FIG. 2 is a circuit diagram of parts of the electronic device of FIG. 1 in accordance with one embodiment.

### DETAILED DESCRIPTION

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

FIG. 1 shows an electronic device 100 of an embodiment. The electronic device 100 with a first and a second driving structure is capable of switching between a standby state and a working state. The electronic device 100 detects the state and the driving structure for automatically providing different driving voltages based on the detected result. In the embodiment, the electronic device 100 is a TV set. In other embodiments, the electronic device 10 can be a computer or a personal digital assistant (PDA), for example.

The electronic device 100 includes a power supply 10, a processor 20, a driving circuit 30, an operation module 40, a first load module 50, a voltage conversion module 60, and a second load module 70.

The power supply 10 includes a first port P1, a second port P2, and a third port P3. The first port P1 outputs different standby voltages based on different driving structures. The second port P2 outputs a working voltage when the electronic device 100 is in the working state. The first port P1 outputs a first driving voltage when the electronic device 100 is in the first driving structure, and outputs a second driving voltage when the electronic device 100 is in the second driving structure. The first driving voltage and the second driving voltage are lower than the working voltage. In the embodiment, the first driving voltage is 5V, the second driving voltage is 3.3V, and the working voltage is 12V. The third port P3 connects with the operation module 40. In other embodiments, the value of the first driving voltage is in a first predetermined range, the value of the second driving voltage is in a second predetermined range.

The processor 20 connects with the power supply 10, the driving circuit 30, and the operation module 40. The processor 20 detects the voltage of the first port P1 and outputs different control signals to the driving circuit 30 based on the detected result. The processor 20 includes a first output port O1 connected to the driving circuit 30. When the first standby voltage is detected, the processor 20 generates a first control signal through the first output port O1; when the second standby voltage is detected, the processor 20 generates a second control signal through the first output port O1.

The driving circuit 30 connects with the power supply 10, the processor 20, and the voltage conversion circuit 60. The driving circuit 30 outputs different standby voltages based on different control signals. The driving circuit 30 includes a first adjustment module 31, and a first switch module 32 which are connected between the power supply 10 and the processor 20 in parallel.

The first adjustment module 31 converts the first driving voltage into a first standby voltage in response to the first control signal, and is disabled to convert the first driving voltage in response to the second control signal. In the embodiment, the first adjustment module 31 is a low dropout regulator (LDO).

The first switch module 32 cuts off a connection between the power supply 10 and the processor 20 in response to the first control signal, and establishes a connection between the power supply 10 and the processor 20 for outputting a second standby voltage in response to the second control signal. In the embodiment, the second standby voltage is 5V.

The processor 20 further includes a first switch port S1. The first switch port S1 connects to the first adjustment module 31 and the second switch module 36. The processor 20 switches into the first standby state of the first driving structure when the first switch port S1 receives the first standby voltage, and switches into the second standby state of the second driving structure when the first switch port S1 receives the second standby voltage.

The processor 20 further comprises a second output port O2. The processor 20 is capable of receiving a power-on instruction from an external device (not shown). When receiving the power-on instruction, the processor 20 generates a power-on signal to the operation module 40 through the second output port O2.

The operation module 40 outputs an enable signal to the third port P3 for controlling the second port P2 to output the working voltage to the first load module 50 and the driving circuit 30.

The first load module 50 works based on the working voltage, and includes a display unit 51 and an audio outputting unit 52.

The driving circuit 30 further comprises a second switch module 34 and a second adjustment module 36 which are connected between the power supply 10 and the processor 20 in parallel.

The processor 20 further comprises a third output port O3. When receiving the power-on instruction and the first driving voltage is detected, the processor 20 further generates a third control signal to the driving circuit 30 through the third output port O3; when receiving power-on instruction and the second driving voltage is detected, the processor 20 further generates a fourth control signal to the driving circuit 30 through the third output port O3

The second switch module 34 establishes a connection between the power supply 10 and the processor 20 for providing a first power-on voltage in response to the third control signal, and cuts off the connection between the power supply 10 and the processor 20 in response to the fourth control signal. In the embodiment, the first power-on voltage is equal to the first driving voltage.

The second adjustment module 36 is connected with the second port P2, and converts the working voltage to generate a second power-on voltage in response to the fourth control signal.

The processor 20 further comprises a second switch port S2. The second switch port S2 connects to the second switch module 34. The processor 20 switches into the first working state of the first driving structure when the second switch port S2 receives the first power-on voltage, and switches into the second working state of the second driving structure when the second switch port S2 receives the second power-on voltage.

The voltage conversion module 60 connects with the second switch module 34, the second adjustment module 36, and the second load module 70. The voltage conversion module 60 converts the first power-on voltage into different sub-working voltages when the second switch module 34 establishes the connection between the power supply 10 and the processor 20. The voltage conversion module 60 further converts the second power-on the voltage into different sub-working voltages when the second adjustment module 36 provides the second power-on voltage to the processor 20. In the embodiment, the voltage conversion module 60 can be a LDO, a DC-DC voltage regulator, or the combination of the LDO and the DC-DC voltage regulator.

The second load module 70 includes a number of loads working on the sub-working voltages. In the embodiment, the loads can be a calibrated element, a Read-Only Memory (ROM), and a Synchronous Dynamic Random Access Memory (SDRAM), for example.

FIG. 2 shows that the first switch module 32 includes a first transistor Q1a switch chip U1, a first resistor R1, a second resistor R2, a third resistor R3, a first capacitor C1, a second capacitor C2, a third capacitor C3, and a fourth capacitor C4. A base of the first transistor Q1 is connected to the first output port O1 through the first resistor R1. An emitter of the first transistor Q1 is grounded. A collector of the first transistor Q1 is connected to the first port P1 through the second resistor R2. Opposite terminals of the second capacitor C2 are connected to the base of the first transistor Q1 and ground respectively. The switch chip U1 includes input pins 240, an enable pin 242, and output pins 244. The input pins 240 are connected to the first port P1. The output pins 244 are connected to the second switch port S2. The enable pin 242 is connected to the first port P1 through the second capacitor C2. Opposite terminals of the third resistor R3 are connected to the collector of the first transistor Q1 and the enable pin 242 respectively. Opposite terminals of the fourth capacitor C4 are connected to the enable pin 242 and ground respectively. In the embodiment, the circuit diagram of the second switch module 34 is the same as the first switch module 32; the first transistor Q1 is an npn type bipolar junction transistor.

The operation module 40 includes a second transistor Q2, a fifth capacitor C5, a fourth resistor R4, a fifth resistor R5, a sixth resistor R6, and a seventh resistor R7. A base of the second transistor Q2 is connected to the third output port O3 through the fifth resistor R5. An emitter of the second transistor Q2 is grounded. A collector of the second transistor Q2 is connected to the first port P1 through the fourth resistor R4. Opposite terminals of the sixth resistor R6 are connected to the collector of the second transistor Q2 and the third output port O3 respectively. Opposite terminals of the seventh resistor R7 are connected to the third output port O3 and ground respectively. Opposite terminals of the fifth capacitor resistor C5 are connected to the third port P3 and ground respectively. In the embodiment, the second transistor Q1 is an npn type bipolar junction transistor.

When receiving power-on instruction, the third output port O3 outputs a logic low level signal. The voltage difference between the base and the emitter of the second transistor Q2 is less than 0 volt (V), the second transistor Q2 turns off. The voltage of the third port P3 is equal to the voltage of the first port P1 for controlling the second port P2 to output the working voltage.

When the first output port O1 outputs a second control signal, the voltage difference between the base and the emitter of the first transistor Q1 is more than 0.7V, the first transistor Q1 turns on. The voltage of the enable pin 242 is changed to a logic low level signal for trigging the switch chip U1. The output pin 244 outputs the first driving voltage or the second driving voltage to the second switch port S2 for switching the processor 20 into the first working state or the second working state when the switch chip U1 is trigged.

In use, the electronic device 100 automatically switches between the two structures driving circuits. Therefore, electronic device 100 provides two different structures driving circuits to satisfy different requirements and misoperation will be reduced.

While various exemplary embodiments have been described, the disclosure is not to be limited thereto. Various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. An electronic device with two driving structures, the electronic device capable of switching between a standby state and a working state comprising:
a power supply for outputting different driving voltages;
a processor; and
a driving circuit connected between the power supply and the processor;
wherein when the electronic device is in the standby state, the processor detects the driving voltage outputted by the power supply and generates different control signals based on the different detected driving voltages, the driving circuit outputs different standby voltages to control the processor working in standby state of different driving structures in response to the different control signals.

2. The electronic device of claim 1, wherein the driving circuit comprises a first adjustment module and a first switch module; when a first driving voltage is detected, the processor generates a first control signal; the first adjustment module coverts the first driving voltage into a first standby voltage and outputs to the processor for switching the processor into a first standby state of the first driving structure in response to the first control signal, the first switch module cuts off a connection between the power supply and the processor in response to the first control signal.

3. The electronic device of claim 2, wherein when a second driving voltage is detected, the processor generates a second control signal to the first adjustment module and the first switch module; the first adjustment module is disabled in response to the second control signal, the first switch module establishes the connection between the power supply and outputs a second standby voltage for switching the processor into a second standby state of the second driving structure in response to the second control signal.

4. The electronic device of claim 2, further comprising an operation module and first load module, wherein when receiving a power-on instruction for switching the electronic device into the working state from an external device, the processor further generates a power-on signal, the operation module controls the power supply to output a working voltage to the first load module in response to the power-on signal.

5. The electronic device of claim 4, wherein the driving circuit further comprises a second switch module and a second adjustment module; when receiving the power-on instruction and the first driving voltage is detected, the processor further generates a third control signal; the second switch module establishes a connection between the power supply and outputs a first power-on voltage to the processor for switching the processor into a first working state of the first driving structure in response to the third control signal, the second adjustment module is disable in response to the third control signal.

6. The electronic device of claim 5, wherein when receiving the power-on instruction and the second driving voltage is detected, the processor further generates a fourth control signal to the second adjustment module and the second switch module; the second switch module cuts off the connection between the power supply, the second adjustment module converts the working voltage to a second power-on voltage and outputs the second power-on voltage to the processor for switching the processor into the second working state of the second driving structure in response to the fourth control signal.

7. The electronic device of claim 6, further comprising a voltage conversion module and a second load module, wherein the voltage conversion module connects to the second switch module, the second adjustment module, and the second load module; when the second switch module outputs the first power-on voltage, the voltage conversion module converts the first power-on voltage into different sub-working voltages; when the second adjustment module outputs the second power-on voltage, the voltage conversion module converts the second power-on voltage into different sub-working voltages; the second load module comprises a plurality of different loads driven by the sub-working voltages respectively.

8. The electronic device of claim 4, wherein the power supply comprises a first port; the processor comprises a first output pin and a switch pin; first switch module comprises a first transistor, a switch chip, a first resistor, a first capacitor, and a second capacitor; a base of the first transistor is connected to the first output pin; an emitter of the first transistor is grounded; a collector of the first transistor is connected to the first port through the first resistor; the switch chip comprises includes input pins, an enable pin, and output pins; the input pins are connected to the first port; the output pins are connected to the switch pin; the enable pin is connected to the first port through the first capacitor; opposite terminals of the second capacitor are connected to the enable pin and ground respectively.

9. The electronic device of claim 8, wherein the power supply further comprise a second port; the processor further comprises a third output pin; the operation module comprises a second transistor, a second resistor; a base of the second transistor is connected to the third output pin; an emitter of the second transistor is grounded, a collector of the second transistor is connected to the first port through the second resistor and also is connected to the second port.

10. An electronic device with two driving structures, the electronic device capable of switching between a standby state and a working state, the electronic device comprising:
a power supply capable of outputting a first driving voltage or a second driving voltage;
a processor; and
a driving circuit connected between the power supply and the processor;
wherein the processor detects whether the power supply outputs a first driving voltage to determine the driving structure of the processor, the processor further detects whether the electronic device receives a power-on instruction for powering on the electronic device from an external device to determine a state of the electronic device; the processor outputs different control signals based on the detected result for controlling the driving circuit to output different voltages, the processor works in different states based on the different voltage.

11. The electronic device of claim 10, wherein when not receiving the power-on instruction and the first driving voltage is detected, the processor generates a first control signal to control the driving circuit to output a first standby voltage for driving the processor to work in a first standby state of the first driving structure.

12. The electronic device of claim 11, wherein when not receiving the power-on instruction the second driving voltage is detected, the processor generates a second control signal to control the driving circuit to output a second standby voltage for driving the processor to work in a second standby state of the second driving structure.

13. The electronic device of claim 11, wherein when receiving the power-on instruction and the first driving voltage is detected, the processor generates a third control signal to control the driving circuit to output a first working voltage for driving the processor to work in a first working state of the first driving structure.

14. The electronic device of claim 11, wherein when receiving the power-on instruction and the second driving voltage is detected, the processor generates a fourth control signal to control the driving circuit to output a second working voltage for driving the processor to work in a second working state of the second driving structure.

15. The electronic device of claim 11, wherein the driving circuit comprises a first adjustment module and a first switch module; the first adjustment module coverts the first driving voltage into a first standby voltage to output to the processor in response to the first control signal, the first switch module cuts off a connection between the power supply and the processor in response to the first control signal; the first adjustment module is disabled in response to the second control signal, the first switch module establishes the connection between the power supply and outputs a second standby voltage in response to the second control signal.

16. The electronic device of claim 11, further comprising an operation module and a first load module, wherein when receiving the power-on instruction, the processor further generates a power-on signal, the operation module controls the power supply to output a working voltage to the first load module for switching the electronic device from a standby state to a working state in response to the power-on signal.

17. The electronic device of claim 16, wherein the driving circuit further comprises a second switch module and a second adjustment module; the second switch module establishes a connection between the power supply and outputs a first power-on voltage to the processor in response to the third control signal, the second adjustment module is disable in response to the third control signal; the second switch module cuts off the connection between the power supply, the second adjustment module converts the working voltage to a second power-on voltage and outputs the second power-on voltage to the processor in response to the fourth control signal.

18. The electronic device of claim 16, wherein the power supply comprises a first port; the processor comprises a first output pin and a switch pin; first switch module comprises a first transistor, a switch chip, a first resistor, a first capacitor, and a second capacitor; a base of the first transistor is connected to the first output pin; an emitter of the first transistor is grounded; a collector of the first transistor is connected to the first port through the first resistor; the switch chip comprises input pins, an enable pin, and output pins; the input pins are connected to the first port; the output pins are connected to the switch pin; the enable pin is connected to the first port through the first capacitor; opposite terminals of the second capacitor are connected to the enable pin and ground respectively.

19. The electronic device of claim 18, wherein the power supply further comprise a second port; the processor further comprises a third output pin; the operation module comprises a second transistor, a second resistor; a base of the second transistor is connected to the third output pin; an emitter of the second transistor is grounded, a collector of the second transistor is connected to the first port through the second resistor and also is connected to the second port.
